(19) United States
(12) Patent Application Publication
(10) Pub. No.: US 2017/0055745 A1
(43) Pub. Date: Mar. 2, 2017

(54) Cup Holder With Hanging Hook Suction Cup Towel Clip Idea

(71) Applicant: Evan Boymel, Valencia, CA (US)

(72) Inventor: Evan Boymel, Valencia, CA (US)

(21) Appl. No.: 14/841,241

(22) Filed: Aug. 31, 2015

(51) Int. Cl. A47G 23/02; A47K 10/14; F16B 47/00

(52) U.S. Cl. CPC A47G 23/0225; F16B 47/00; A47K 10/14

(57) ABSTRACT

Cup holder with suction cup and hanging hook and towel clip attached to cup holder for purposes of holding a large container/cup and attaching to a surface, while providing a place to hang a towel, and a mechanism (hanging hook) to carry the device with and offer substitute ways to mount device when flat surface is not available.

Fig 101—Cup Holder Top Opening. Made of hardened plastic, it is one continuous piece in a large circle, with an opening large enough to accommodate a wide variety of cups and bottles. The Top Opening is molded as one continuous piece with items marked “Fig 105, 106, 107”.

Fig 102—Plastic Suction Cup Pressurized Latch. The latch is made of hardened plastic. It is attached to the frame via small screws on the inside wall of the latch. When pressed closed, the interior plastic joint which is attached to the suction cup (Fig 105) is pulled towards the latch, creating a high pressure seal that allows the suction cup to stick to a flat surface.

Fig 103—Hanging Hook Base Attachment. The base of the hanging hook attachment will be either a continuation of the frame itself, or can be melded to the frame of the device. It is made of hardened plastic

Fig 104—Hanging Hook—Hook Portion. The Hanging Hook—Hook Portion is made of hardened, curved plastic and is large enough to be held by a human hand, and also large enough to hang off of an external bar or beam or piece of equipment. Other possibilities include fences, weight benches, barbells, and handrails.

Fig 105—High Pressure Suction Cup. Constructed of either PVC Plastic or Neoprene. The suction cup is attached to the Plastic Suction Cup Pressurized Latch (Fig 102) via an interior plastic joint. When the latch in Fig 102 is pressed closed, the High Pressure Suction Cup is activated against a smooth surface and creates suction so the device holds.

Fig 106—Plastic Arm or Shaft. This piece is made of hardened plastic. It is one continuous piece attached to items marked “Fig 101, 105, 107”.

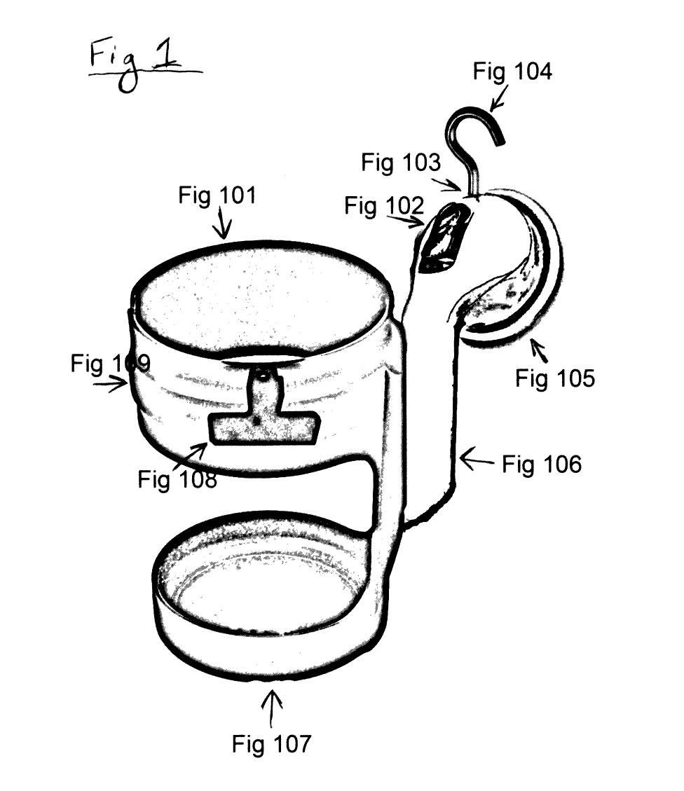

Fig 107—Cup Holder Base. This Piece is the base for supporting a cup or bottle once placed inside the “Fig 1” Cup Holder. It is made of hardened plastic. It is one continuous piece attached to items marked “Fig 101, 105, 106”.

Fig 108—Towel Clip. The towel clip is made of two separate pieces of hardened plastic, connected in the center by a small connector piece of plastic. The outside has a coiled metal spring to give it pressure when closed to hold towel. The back side is melded to the frame of the “Fig 1” Cup Holder with heated plastic or high strength glue.

Fig 109—Name Plate. Made of Curved Melamine and attached to the “Fig 1” Cup Holder. This piece is either glued on or melded on to the “Fig 1” Cup Holder frame. User can use it to write his/her name on the device.

1. The Cup Holder with Hanging Hook and Suction Cup and Towel Clip Idea allows a person to keep their cup/sports drink/bottle attached to a mirror or other surface, therefor off the ground, reducing the chances of spilling.
The towel clip gives the user a place to put their towel they use in the gym to wipe sweat off with that is off the floor and therefor more sanitary.
The hanging hook allows the user to carry the device from place to place, and if there is not a surface to mount the suction cup too, they can hang it from pieces of gym equipment with the hook.
The cup holder with suction cup has a pressurized suction cup that utilizes a high-pressure latch that presses that suction cup against a flat surface creating a tight seal so it can be attached to a mirror at a gym or other surface in other locations, keeping it off the ground. The entire device will be one continuous molded piece of plastic
The hook is melded to the top of the device and is made of melded plastic as well.
The towel clip will made of plastic with a small metal spring to allow the clip to stay closed and hold the users towel.
This is different from other cup holders on the market as it allows the owner to place their cup/sports drink high off the ground, out of the way of other people's feet, which could potentially knock over their drink, while giving them a place to store their sports towel and a convenient and easy way to carry the device (as well as a backup for mounting in case there is no flat surface for the suction cup).
